(19) United States
(12) Patent Application Publication
(10) Pub. No.: US 2019/0032487 A1
(43) Pub. Date: Jan. 31, 2019

(54) Cylinder assembly of an orc engine

(71) Applicant: DEVETEC GMBH, St. Ingbert (DE)

(72) Inventors: Rainer SCHNUR, Morscholz (DE); Joscha HORBACH, Konken (DE)

(21) Appl. No.: 15/998,543

(22) PCT Filed: Feb. 6, 2017
(86) PCT No.: PCT/DE2017/100085

§ 371 Date: Aug. 16, 2018

(30) Foreign Application Priority Data
Feb. 16, 2016 (DE) 10 2016 102 649.2

(51) Int. Cl. F01B 9/02; F16C 5/00; F16C 11/04; F16C 9/04

(52) U.S. Cl. CPC F01B 9/02; F16C 5/00; F16C 2360/22; F16C 9/04; F16C 11/045

(57) ABSTRACT

The invention relates to an assembly of an ORC engine with a crosshead for the articulated connection of a piston rod of a piston, which is guided in a working cylinder, to a connecting rod of the ORC engine, wherein the crosshead is movable in a guide in the longitudinal direction of the piston rod. The crosshead can be detached from the connecting rod in the direction of the working cylinder without complete or partial dismounting of the guide. By means of the guide, free space can be left for the dismounting of the crosshead with axial displacement of a connecting-rod pin, and/or the crosshead can be broken down into parts for dismounting purposes.

### TECHNICAL FIELD

The disclosure relates to a cylinder assembly of an ORC engine having a crosshead for the articulated connection of a piston rod of a piston, which is guided in a working cylinder, to a connecting rod of the ORC engine, the crosshead being movable in a guide in the longitudinal direction of the piston rod.

### BACKGROUND

ORC engines which are known from practice and have such an assembly build upon internal combustion engines, the cylinder bushings of which are used to guide the crosshead. The working cylinder guiding the piston directly coaxially adjoins a cylinder bushing of the internal combustion engine. Removal of the working cylinder and of the structural unit formed by the piston, piston rod and crosshead for the purposes of repair and maintenance is associated with high outlay, in particular with additional dismantling of the cylinder bushings of the internal combustion engine.

### SUMMARY

The present disclosure provides an installation-friendly novel cylinder assembly of the type mentioned in the introduction which is characterised in that the crosshead can be detached from the connecting rod in the direction towards the working cylinder without complete or partial removal of the guide.

Sufficient free space can be left by the guide for the removal of the crosshead with axial displacement of a connecting rod pin, and/or the crosshead can be broken down into parts for the purposes of removal from the connecting rod. For example, the crosshead can be so small in comparison with the diameter of a bushing-shaped guide that the connecting rod pin connecting the crosshead and the connecting rod can be pushed laterally sufficiently far out of its rotary bearings. Alternatively, the crosshead could be formed from at least two half-shells which enclose the connecting rod pin.

When the crosshead is detached from the connecting rod, it is preferably possible for a structural unit comprising the crosshead, the piston rod and the piston to be decoupled in its entirety from the connecting rod.

In a preferred embodiment of the disclosure, the crosshead comprises fork legs which have through-openings for the connecting rod pin and between which the free end of the connecting rod comes to be arranged.

Preferably, the crosshead is secured by the guide against rotation about the longitudinal axis of the piston rod. Torques exerted on the said structural unit during installation work can advantageously be absorbed thereby.

The guide preferably has a guide bushing which is coaxial to the longitudinal axis of the piston rod and has guide rails protruding from the bushing inner wall. For example, pairs of mutually diametrically opposite guide faces, in particular flat guide faces, for the crosshead can be formed by the guide rails.

In particular, the fork legs protrude from a section of the crosshead which is preferably conical and can be connected to the piston rod. The conical shape of the crosshead ensures uniform transmission and distribution of the piston force via the piston rod to the fork legs.

In a particularly preferred embodiment of the disclosure, there is a detachable connection, in particular a screw connection, between at least one of the fork legs and the section. The crosshead can thus be broken down into parts, which allows it to be removed even if the connecting rod pin can only be displaced to a limited extent.

In a further embodiment of the disclosure, the piston rod is in the form of a hollow body.

Preferably, the crosshead can be screw-fastened to the piston rod and the piston rod can be screw-fastened to the piston via threads which are coaxial to the longitudinal axis of the piston rod.

The thread diameter of the screw-fastening of the piston rod to the crosshead is preferably greater than the thread diameter of the screw-fastening of the piston rod to the piston. This allows the piston to be detached from the piston rod separately without undoing the screw-fastening between the piston rod and the crosshead.

In a further embodiment of the disclosure, a dowel pin connection is produced in each case in addition to the said screw-fastenings. The dowel pin connection ensures that the piston always assumes the same rotary position in relation to the crosshead.

### BRIEF DESCRIPTION OF THE DRAWINGS

The disclosure is explained in more detail below using exemplary embodiments and the attached drawings relating to one of these exemplary embodiments. In the figures:

FIG. 1 shows an assembly according to the disclosure, which comprises a crosshead, of an ORC engine in a cut-away side view, and

FIG. 2 shows a cut-away plan view of the assembly of FIG. 1.

### DETAILED DESCRIPTION OF THE DRAWINGS

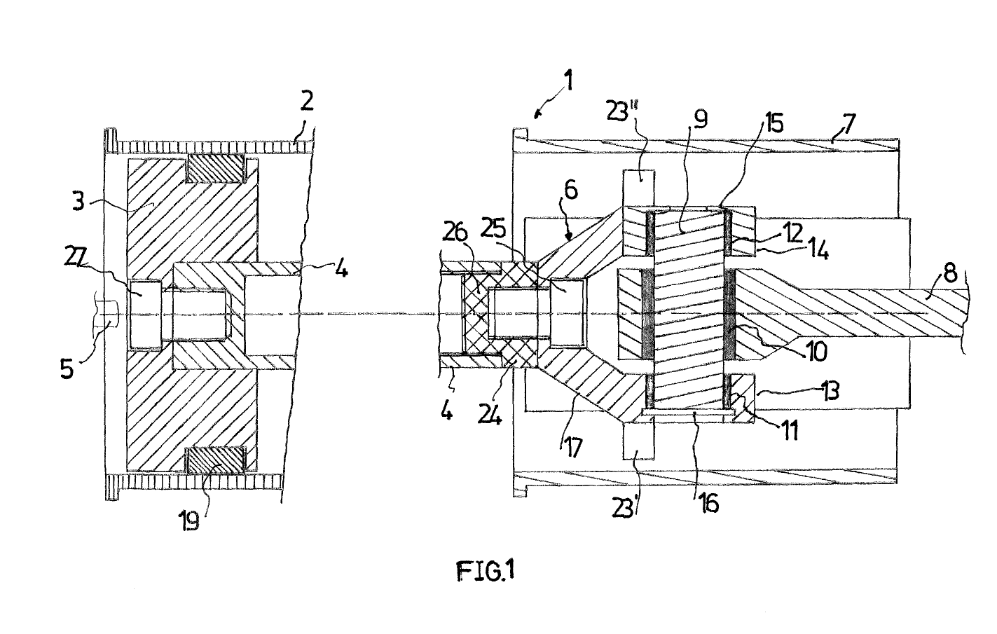

An assembly 1, shown in FIG. 1, of an ORC engine comprises a working cylinder 2, in which a piston 3 and a piston rod 4 connected rigidly to the piston 3 are guided. A pin-like element 5 for actuating an inlet valve, accommodated in the cylinder head, for a pressurised working medium protrudes centrally against the piston 3 from a cylinder head (not shown) which terminates the working cylinder 2.

At its end remote from the piston 3, the piston rod 4 is connected to a crosshead 6, which is guided in a direction parallel to the longitudinal direction of the piston rod 4 inside a bushing 7, which is coaxial to the working cylinder 2, and is in turn connected to a connecting rod 8 which moves the crosshead 6.

In the exemplary embodiment shown, the bushing 7 is a cylinder bushing of an internal combustion engine which forms the basis for the ORC engine, in which the working cylinder 1 and the structural unit of the ORC engine which forms the piston 3, the piston rod 4 and the crosshead 6 take the place of the piston and the cylinder head of the internal combustion engine.

The articulated connection of the connecting rod 8 to the crosshead 6 is provided by a connecting rod pin 9, which is mounted rotatably in a bearing bushing insert 10 of the connecting rod 8.

As can be seen in FIG. 1, the connecting rod pin 9 protrudes at both ends into a bearing bushing insert 11 and 12, respectively, the bearing bushing inserts 11, 12 each being arranged in a through-opening in a fork leg 13 and 14, respectively, of the crosshead 6. The connecting rod pin 9 is fixed axially in position in the bushing inserts 10 to 12 by a limiting wall 15 in the opening in the fork leg 14 and by a snap ring 16 accommodated in a groove in the opening in the fork leg 13.

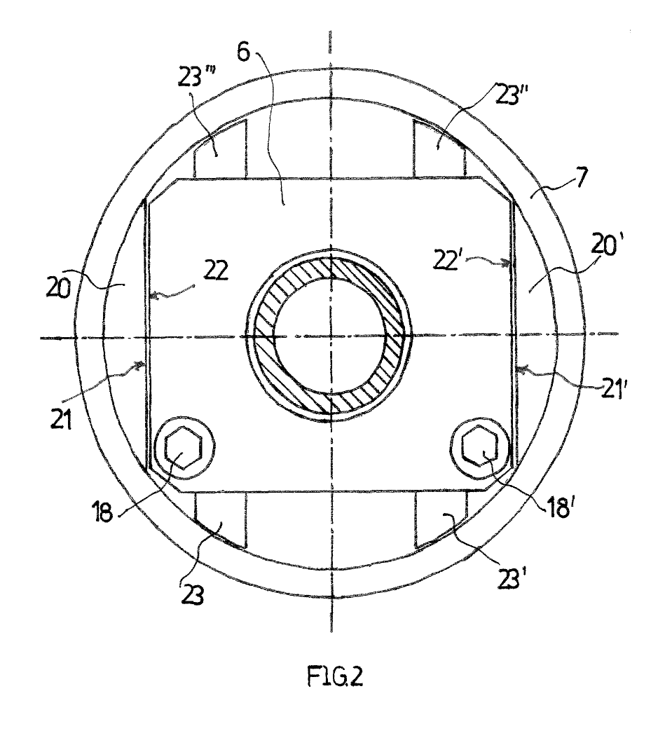

As can be seen in FIG. 1, the crosshead 6 comprises a conical section 17 which merges integrally into the fork leg 13. The fork leg 14 is connected detachably to the conical section 17 by screws 18 and 18′ (FIG. 2).

As can be seen in FIG. 2, mutually diametrically opposite guide rails 20 and 20′ are attached to the inner wall of the bushing 7 and each have two flat guide faces 21 and 21′ spaced apart from each other. Corresponding flat bearing faces 22 and 22′ of the crosshead 6 bear slidingly against these guide faces 21, 21′.

It is self-evident that the crosshead is secured against rotation about the longitudinal axis of the piston rod 4 by the contact with the four guiding faces. Four guide pegs 23, 23′, 23″ and 23′″ which protrude from the crosshead 6 against the inner wall of the bushing 7 and slide on the inner face of the bushing 7 fix the crosshead 6 in position inside the bushing 7, in the direction parallel to the guide faces.

The partially hollow, conical section 17 is connected on its side facing away from the connecting rod 8 to the piston rod 4 via an intermediate piece 24. A screw 25 connects the conical section 17 to the intermediate piece 24. An end section 26 of the intermediate piece 24 has an external thread which is screw-fastened to an internal thread of the piston rod 4 in the form of a hollow body.

In contrast to the example shown, the intermediate piece 24 could also be formed integrally with the conical section 17 or the piston rod 4.

The piston 3 provided with a guide ring 19 can be screw-fastened to the piston rod 4 with the aid of a central screw 27.

It is self-evident that the bushing 7 is connected to a crankcase (not shown) and that the working cylinder 2 is connected to a cylinder bank (not shown), which may have multiple such bushings 7, coaxially to the bushing 7.

In the event of repair or maintenance work, after the working cylinder 2 has been dismantled, the entire structural unit comprises the piston 3, the piston rod 4 and the crosshead 6 can be removed by undoing the connection between the crosshead 6 and the connecting rod 8, as follows:

First, the snap ring 16 is removed with the aid of a tool inserted into the bushing 7. Owing to the free space between the relevant pin end and the inner wall of the bushing 7, the connecting rod pin 9 can then be displaced axially until the other end of the connecting rod pin 9 no longer engages in the bearing bushing section 12. In the next removal step, the screws 18 and 18′ are unscrewed and the fork leg 14 is removed. After the connecting rod pin 9 has been displaced axially in the opposite direction until the connecting rod pin 9 is disengaged from the bearing bushing insert 11 of the fork leg 13, the said structural unit can be decoupled from the connecting rod 8 in the direction of the axis of the bushing 7 towards the cylinder head.

The guide pegs 23, 23′, 23″ and 23″′ leave enough free space in the bushing 7 for the aforementioned installation steps to be carried out and therefore can stay in place during installation. They are dowelled non-detachably to the bushing 7 in the example shown.

It is self-evident that the guide faces 21, 21′ formed by the guide rails 20, 20′ do not allow any rotation of the crosshead 6 about the axis of the bushing 7.

This guide which absorbs torques about the bushing axis allows separate removal of only the piston 3 when the structural unit comprises the piston 3, the piston rod 4 and the crosshead 6 is installed, without problems.

Torques arising when the central screw 27 is unscrewed are absorbed by the guide without problems.

Undesirable loosening of the screw-fastening of the piston rod 4 to the intermediate piece 24 when the screw 27 is undone is prevented in that, owing to the greater thread diameter, a higher torque is required to undo the screw-fastening than to unscrew the screw 27.

Normally, the actuating element 5 impacts the piston 3 vertically in the centre of the piston close to the top dead centre of the piston 3. Transverse forces resulting from deviations in the impact position and the impact angle within tolerance limits are absorbed by the guide of the aforementioned assembly in the working cylinder 2 via the guide ring 19 and in the bushing 7 by the rails 20, 20′ and the inner wall of the bushing 7 against which the guide pegs 23, 23′, 23″, 23″′ bear.

Transverse forces can be intensified if, after installation work, the actuating element 5 impacts the piston 3 offset to a depression formed by constant impact against the piston surface. Therefore, during installation work, it must be ensured that the piston is situated in its previous rotary position again after assembly. The reproducibility of the rotary position can be ensured by dowelling between the piston 3 and the piston rod 4 and between the piston rod 4 and the crosshead 6.

1. A cylinder assembly of an ORC engine having a crosshead for the articulated connection of a piston rod of a piston, the crosshead is guided in a working cylinder, to a connecting rod of the ORC engine, the crosshead being movable in a guide in the longitudinal direction of the piston rod, wherein
the crosshead can be detached from the connecting rod in the direction towards the working cylinder without complete removal or partial removal of the guide.

2. The assembly according to claim 1, wherein
sufficient free space is left by the guide for the removal of the crosshead with axial displacement of a connecting rod pin or the crosshead can be broken down into parts for the purposes of removal.

3. The assembly according to claim 1, wherein
when the crosshead is detached from the connecting rod, it is possible for a structural unit formed by the crosshead, the piston rod, and the piston to be decoupled in its entirety from the connecting rod.

4. The assembly according to claim 2, wherein
the crosshead comprises fork legs which have through-openings for the connecting rod pin and between which the free end of the connecting rod is disposed.

5. The assembly according to claim 4, wherein
the fork legs protrude from a section of the crosshead which is conical and configured to be connected to the piston rod.

6. The assembly according to claim 5, wherein
there is a detachable connection by means of screws between at least one of the fork legs and the conical section.

7. The assembly according to claim 1, wherein
the crosshead is secured by the guide against rotation about the longitudinal axis of the piston rod.

8. The assembly according to claim 1, wherein
the guide has a guide bushing coaxial to the longitudinal axis of the piston rod and further includes guide rails protruding from the bushing inner wall.

9. The assembly according to claim 8, wherein
mutually diametrically opposing guide faces, where appropriate pairs of in particular flat guide faces, are formed by the guide rails.

10. The assembly according to claim 8, wherein
the guide bushing is a cylinder liner of an internal combustion engine forming the basis for the ORC engine.

11. The assembly according to claim 1, wherein
the piston rod is in the form of a hollow body.

12. The assembly according to claim 1, wherein
the crosshead is configured to be screw-fastened to the piston rod and the piston rod is configured to be screw-fastened to the piston via threads which are coaxial to the longitudinal axis of the piston rod.

13. The assembly according to claim 12, wherein
the thread diameter of the screw-fastening of the piston rod to the crosshead is greater than the thread diameter of the screw-fastening of the piston rod to the piston.

14. The assembly according to claim 12, wherein
in each case a dowel pin connection is produced in addition to the screw-fastenings.

15. A crosshead for an assembly according to claim 1.
